(19) United States
(12) Patent Application Publication
(10) Pub. No.: US 2024/0415145 A1
(43) Pub. Date: Dec. 19, 2024

(54) NOVEL BINDER

(71) Applicant: DSM IP ASSETS B.V., HEERLEN (NL)

(72) Inventor: Petrus Jacobus Theodorus DEKKER, ECHT (NL)

(21) Appl. No.: 18/698,609

(22) PCT Filed: Oct. 11, 2022
(86) PCT No.: PCT/EP2022/078265

§ 371 Date: Apr. 4, 2024

(30) Foreign Application Priority Data
Oct. 11, 2021 (EP) 21201830.3

(51) Int. Cl. A23J 3/20; A23C 20/02; A23J 3/16; A23J 3/22

(52) U.S. Cl. CPC A23J 3/20; A23C 20/02; A23J 3/16; A23J 3/227

(57) ABSTRACT

The present disclosure relates to the field of food. Herein disclosed is a method for preparing a non-animal protein food product or a cultured meat food product comprising adding a lactase protein preparation to an ingredient used in the preparation of said food product and processing the obtained lactase protein preparation and ingredient composition into a non-animal protein food product or a cultured meat food product.

### FIELD

The present invention relates to the field of food.

### BACKGROUND

Food products comprising non-animal proteins (for example plant proteins) as alternative to animal-derived proteins nowadays receive attention because of consumer concerns about the environmental impact of animal-based products and the beneficial nutritional characteristics of non-animal protein based foods. In particular, beverages based on plant proteins as alternative to dairy products such as milk, yoghurt or ice cream have gained popularity.

The many disadvantages associated with the use of animal-derived protein for human consumption, ranging from acceptability of raising animals for consumption to the fact that such meat production is inefficient in terms of feed input to food output and carbon footprint, makes the ongoing search for improved meat alternatives one of the most active food developments in present day society.

Historically, meat alternatives achieve a certain protein content using fermented vegetable sources such as soy (e.g. tofu, tempeh) or gluten/wheat (e.g. seitan). Today, modern techniques as extrusion and 3D-printing are used to make meat alternatives with more meat-like texture, flavor and appearance. Soy and gluten are still favorable sources for such meat alternatives because they are widely available, affordable, relatively high in protein and well processable. However, GM-produced soy and gluten intolerance or allergenicities are triggering consumer demands for alternatives. Producers of meat alternatives turn to other proteins, for example like those derived from legumes, e.g. pea. However, use of these alternative protein sources is accompanied with new problems. The protein mixtures are often not as easily processible as the traditional soy or gluten or their combinations, and in many cases also lead to texturized food proteins that do not mimic the nutrition, texture, appearance, and/or the taste of animal-derived meat products. As a result, consumers typically consider such meat alternatives unappealing and unpalatable. Hence, there is a need in the art for meat alternatives that are appealing and palatable.

A commonly used binder, or binding agent, in dairy- or meat alternatives is methyl cellulose. Methyl cellulose is undesired in view of the food label requirements requiring mentioning of such chemical. Consumers more and more desire clean label food products. Other common binders are wheat gluten or egg protein. The disadvantage of wheat gluten is that is a potential allergen. Further, the disadvantage of egg protein is that the produced food item is not vegan, and a potential allergen.

WO2018115595 (CN110062582) describes a process for manufacturing a heat stable plant based protein product wherein lactase and/or a protease is/are optionally added after a heat treatment step. Page 9, lines 28 and 29 as well as lines 34 to 36 of WO2018115595 describe that lactase is added to hydrolyze lactose.

In general there is a need for alternative binders, preferably binders that are non-allergenic and/or vegan.

### SUMMARY

The invention provides:
a method for preparing a non-animal protein food product or a cultured meat food product comprising
   adding a lactase protein preparation to an ingredient used in the preparation of said food product and processing the obtained lactase protein preparation and ingredient composition into a non-animal protein food product or a cultured meat food product;
a food product obtainable by one of the herein described methods;
meat or fish alternative food product comprising non-animal protein or cultured meat and a lactase protein preparation;
meat or fish alternative which comprises texturized vegetable protein, non-animal protein, water, flavour and a binder system, wherein the binder system comprises a lactase protein preparation; and
use of a lactase protein preparation for obtaining binding in a food product or for at least partly replacing a binder in a food product.

### DETAILED DESCRIPTION

Food binders are food additives that are added to food products for the purpose of improving texture via thickening or binding the ingredients together. Food binders play an important role in the production of food by for example improving texture, juiciness and/or increasing volume.

Examples of widely use food binders are eggs, wheat flour, oatmeal, rice, milk, gelatine, guar gum, xanthan gum, (potato) starch or methyl cellulose.

There is a need in the art for alternative binders. The present application addresses this need.

As disclosed herein within the experimental part, a lactase protein preparation can surprisingly be used as a binder.

Throughout the present specification and the accompanying claims, the words “comprise”, “include” and “having” and variations such as “comprises”, “comprising”, “includes” and “including” are to be interpreted inclusively. That is, these words are intended to convey the possible inclusion of other elements or integers not specifically recited, where the context allows.

The articles “a” and “an” are used herein to refer to one or to more than one (i.e. to one or at least one) of the grammatical object of the article. By way of example, “an element” may mean one element or more than one element.

In one of its aspects, the invention provides a method for preparing a non-animal protein food product or a cultured meat food product comprising
adding a lactase protein preparation to an ingredient used in the preparation of said
food product and processing the obtained lactase protein preparation and ingredient composition into a non-animal protein food product or a cultured meat food product.

Alternatively, this aspect of the invention can be worded as:
a method for preparing a non-animal protein food product comprising adding a lactase protein preparation to an ingredient used in the preparation of said food product and processing the obtained lactase protein preparation and ingredient composition into a non-animal protein food product, or
a method for preparing a cultured meat food product comprising adding a lactase protein preparation to an ingredient used in the preparation of said food product and processing the obtained lactase protein preparation and ingredient composition into a cultured meat food product.

The term “non-animal protein food product” as used herein refers to a food product which does not comprise animal protein.

The term “cultured meat food product” as used herein refers to a food product which is prepared from cultured meat. Cultured meat is a meat produced by in vitro cell cultures of animal cells. It is a form of cellular agriculture. Cultured meat is produced using tissue engineering techniques traditionally used in regenerative medicines.

The term “an ingredient used in the preparation” as used herein covers any ingredient which is used in the preparation of a non-animal protein food product or a cultured meat food product. A suitable ingredient depends on the final non-animal protein food product or a cultured meat food product. As a non-limiting example, a meat alternative product such as a hamburger patty, sausages, or nuggets is described herein in more detail. Typical ingredients of such a meat alternative are texturized vegetable protein, (non-animal) protein, oil and/or fat, water and a flavour system. The lactase protein preparation may be added to any of these ingredients, for example to the texturized vegetable protein or to the protein or to the oil and/or fat or to the water or to the flavour system. In one of the embodiments, all (or part) of the ingredients of the non-animal protein food product or a cultured meat food product are added to each other (and optionally mixed) and in a next step the lactase protein preparation is added. In yet another embodiment, all ingredients of the non-animal protein food product or a cultured meat food product and the lactase protein preparation are added to each other at approximately the same time. In one of the embodiments the lactase protein preparation may be added during the preparation of the texturized vegetable protein.

In case the meat or fish alternative is based on a High Moisture Extrudate (HME), the lactase protein preparation may be added during the preparation of the HME, or alternatively to the HME or to any of the other usual ingredients (e.g. oils, fats, proteins, vitamins, minerals) of the meat or fish alternative.

In case the meat or fish alternative is based on Shear Cell Technology, the lactase protein preparation may be added during the preparation of the protein slab, or alternatively to the protein slab or to any of the other usual ingredients (e.g. oils, fats, proteins, vitamins, minerals) of the meat or fish alternative.

In case the non-animal protein food product is a vegan cheese (also referred to as plant-based dairy cheese alternative), the term “an ingredient used in the preparation” typically includes a starch, gums and/or a non-animal protein source as binder, vegetable fats or oil and other ingredients (salt, calcium, acid, preservatives, flavourings, color).

In case the non-animal protein food product is a plant-based milk or yogurt (also referred to as plant-based dairy alternative), the term “an ingredient used in the preparation” typically includes plant-based milks like soy, oat, coconut, rice, almond, and lactic acid bacteria (in yoghurt) and other ingredients (starches or gums, vitamins, flavourings, sugars etc).

In case the non-animal protein food product is a vegan omelet or other egg-replacer, the term “an ingredient used in the preparation” typically includes plant-based protein, binders like methylcellulose, and other ingredients (flavourings, color).

The step of adding a lactase protein preparation to an ingredient used in the preparation of a non-animal protein food product or a cultured meat food product, generally comprises
combining a lactase protein with plant protein, microbial protein or algal protein
combining a lactase protein with plant protein
combining a lactase protein with microbial protein
combining a lactase protein with fungal protein
combining a lactase protein with bacterial protein
combining a lactase protein with algal protein
combining a lactase protein preparation with texturized vegetable protein
combining a lactase protein preparation with a plant-based milk
preparing of a binder phase wherein said lactase protein preparation is combined with oil or fat and water
preparing of a binder phase wherein said lactase protein preparation is combined with oil or fat, water and a hydrocolloid
combining a lactase protein preparation with other dry ingredients
combining a lactase protein preparation with other dry ingredients, oil and water
combining a lactase protein preparation with seasoning (such as, but not limited to, salt and/or pepper), or
combining a lactase protein preparation with water and a yeast extract

The phrase “processing the obtained lactase and ingredient composition into a non-animal protein food product or a cultured meat food product” comprises well know steps such as mixing, kneading, fermenting, cooking, frying, baking, freezing, extrusion, shear cell technology and many others.

The term “obtained lactase protein preparation and ingredient composition” refers to the composition which is obtained when a lactase protein preparation is added to an ingredient used in the preparation of any of said food products.

Lactase is an enzyme which is produced by many organisms. Its primary commercial use is to break down lactose in milk to make it suitable for people with lactose intolerance. The herein described method does not rely on the enzymatic activity of lactase. As disclosed herein in the experimental part lactase protein is very suitable as a binder and hence disclosed herein is a method for preparing a non-animal protein food product or a cultured meat food product comprising
adding a lactase protein preparation to an ingredient used in the preparation of said food product and processing the obtained lactase protein preparation and ingredient composition into a non-animal protein food product or a cultured meat food product, wherein said lactase protein preparation provides binding properties to the food product when said lactase protein preparation and ingredient composition or said food product is heated to at least 45 degrees Celsius.

The binding properties are obtained by gelling of the lactase protein. Preferably the gelling results in the formation of an irreversible gel.

Preferably, the lactase protein preparation is used to replace a conventional binder such as methylcellulose or egg white protein and hence alternatively phrased, the invention provides a method for reducing (preferably completely reducing) methylcellulose or egg white protein in preparing a non-animal protein food product or a cultured meat food product comprising
adding a lactase protein preparation to an ingredient used in the preparation of said food product and processing the obtained lactase protein preparation and ingredient composition into a non-animal protein food product or a cultured meat food product

In the aspect of the invention which is outlined above (i.e. a method for preparing a non-animal protein food product or a cultured meat food product or a method for reducing (preferably completely reducing) methylcellulose or egg white protein in preparing a non-animal protein food product or a cultured meat food product) said method can comprise a heating step, i.e. the above described method further comprise a step of heating to at least 45 degrees Celsius. As disclosed herein within the experimental part, heating to at least 45 degrees Celsius results in gelling of lactase protein. This is surprising as typically binders such as egg provide gelling at higher temperatures. Eggs contain multiple proteins that gel at different temperatures. Egg yolk becomes a gel or solidifies between 65 and 70 degrees Celsius whereas egg white gels at different temperatures: 60 to 73 degrees Celsius. A suitable upper limit for heating depends on the final product as well as on the used method for heating (for example with or without pressure) and can easily be determined by the skilled person.

Preferably, the non-animal protein food product or a cultured meat food product comprise reduced amounts of egg or said product does not comprise an egg-protein at all. Alternatively worded, the herein claimed method does not comprise a step wherein egg protein is added.

The reduction of the amount of egg which is possible according to the method described herein differs per food product. The person skilled in the art knows the amount of egg which is regularly present in food product recipes. In general a reduction of the amount of egg of at least 5% w/w can be reached. More preferably a reduction of the amount of egg of at least 10% w/w can be reached, even more preferably a reduction of at least 15% w/w can be reached. Even more preferably, a reduction of the amount of egg used of at least 20% w/w can be reached. The reduction of the amount of egg can be at least 30% w/w, 40% w/w or even at least 50% w/w. Even more preferably, the reduction of the amount of egg is at least 60, 70, 80 or 90% w/w. Most preferably, the reduction of the amount of egg is 100%.

Preferably, in the above-described method, the food product does not comprise an egg-protein (natural egg protein as well as any recombinantly produced egg protein) and hence the food product is an egg-free food product. Alternatively worded, the above-described methods exclude the addition of egg.

The terms “egg protein”, “egg white” or “egg” are used interchangeably herein and when used in combination with “binding”, “binder” or “gelation” herein refer to an egg-derived or egg-labelled product, either the whole egg, parts of an egg (incl. egg yolk), an isolated fraction of an egg, or a single egg protein produced by another host that provides binding properties.

The lactase protein preparation as used in the herein claimed method replaces binders such as—but not limited to—egg white. In case a lactase protein preparation is added to replace egg white said lactase protein preparation is added to replace the heat gelation function of egg white protein.

The term “lactase” is explained above. Lactase is typically sold as a lactase protein preparation which does not only comprise the lactase protein but also other components such as a salt and/or a preservative. Lactase preparations have been described for and isolated from a large variety or organisms, including micro-organisms. Lactase is often an intracellular component of micro-organisms like Kluyveromyces and Bacillus. Kluyveromyces and especially K. fragilis and K. lactis, and other yeasts such as those of the genera Candida, Torula and Torulopsis are a common source of yeast enzymes lactases, whereas B. coagulans or B circulans are well known sources for bacterial lactases. Typically, a lactase protein preparation also comprises other components such as other proteins, which are derived from/expressed by the micro-organism. Hence, the lactase protein preparation may comprise other components. For example, the preparation of intracellular lactases requires the disruption of the cells to release the lactase protein. At the same time, other cytoplasmic proteins/enzymes are released. When a lactase protein preparation is used to reduce lactose, it is desired to have a preparation which comprises for examples reduced levels of protease and/or arylsulfatase. For the present invention, crude lactase protein preparations can be used.

Examples of a suitable lactase protein preparation are a lactase protein preparation which comprises
a native lactase protein
a yeast lactase protein
a Kluyveromyces lactase protein
a Kluyveromyces lactis lactase protein
a classical (non-GMO) lactase protein,
an intracellularly produced lactase protein, and/or
any combination thereof.

Preferably, the lactase protein preparation comprises a neutral lactase protein having its pH optimum in the range of pH 6 to 8 or said preparation comprises a Kluyveromyces lactase protein and more preferably the lactase protein is Kluyveromyces lactase which is endogenously expressed by Kluyveromyces. The expression of the lactase protein in Kluyveromyces is preferably enhanced by classical strain improvement. Most preferred is a lactase protein preparation which lactase is endogenously expressed by Kluyveromyces and which expression is enhanced by classical strain improvement.

Suitable examples of a lactase protein preparation are Maxilact products (DSM Food Specialties), Lactozyme (Novozymes), Ha-lactase (Chr. Hansen) and Godo YNL-2 (DuPont).

As described above and as shown in the experimental part herein, other lactase protein preparations can be used as well. Even more preferably, the used lactase protein preparation does not comprise glycerol or any compound (such as maltodextrin) which is typically used in spray drying of enzymes.

As described above, the herein described method does not rely on the enzymatic activity of a lactase and hence the enzymatic activity of the lactase may be inhibited by an inhibitor such as Cu2+ without losing its functionality as binder.

The phrase “native lactase protein” refers to a non-denatured lactase protein. A non-denatured lactase protein can be dissolved in water whereas a denatured (for example by exposing the lactase protein to a low pH or a high temperature) lactase protein cannot be dissolved.

The amount of lactase protein preparation which is added to get the desired binding effect can easily be determined by the skilled person. Guidance can be found in the experimental part herein. Based on total protein (present in the used lactase protein preparation) a dosage of 0.05 to 20% or 0.05 to 10% is sufficient to result in binding. More preferably, at least 0.1% of total protein (present in the used lactase protein preparation) is used and a suitable range is at least 0.1% to 20%. Most preferably, at least 0.5% of total protein (present in the used lactase protein preparation) is used and hence the most preferred range is at least 0.5% to 20%. The presented amounts of lactase protein preparation is relative to the mass of the food product. Not all the proteins in a lactase protein preparation are lactase protein but—as lactase production strains are designed to produce as much lactase protein as possible—an amount of 50% lactase protein (based on total protein in the lactase protein preparation) is typical. Based on lactase protein (present in the used lactase protein preparation) a dosage of 0.025 to 10% or 0.025 to 5% is sufficient to result in binding. More preferably, at least 0.05% of lactase protein (present in the used lactase protein preparation) is used and a suitable range is at least 0.05% to 10%. Most preferably, at least 0.25% of lactase protein (present in the used lactase protein preparation) is used and a suitable range is at least 0.25% to 10%. The presented amounts of lactase protein is relative to the mass of the food product. The skilled person is capable of determining the amount of lactase protein in a lactase protein preparation by using well known methods. For example, HP-SEC or SDS-PAGE analysis can be used to estimate the relative amount of lactase protein in comparison to other proteins in the lactase protein preparation.

The term “non-animal protein food product” as used herein refers to a food product which does not comprise any animal protein. The non-animal protein food product comprises proteins from other sources. The non-animal protein is for example plant protein, microbial protein or algal protein. Suitable examples of a microbial protein are fungal protein or bacterial protein. I.e. the non-animal protein food product is for example a plant protein food product, a microbial protein food product, an algal protein food product, a fungal protein food product or a bacterial protein food product

The term “plant protein food product” as used herein refers to a “food product comprising a plant protein” (alternatively referred to as “plant protein comprising food product”; the phrases are used interchangeably herein) which refers to a food product which comprises at least 10% (based on all proteins present in said food product) plant protein. Preferably, said plant-based food product comprises at least 20%, 30%, 40%, 50%, 60%, 70%, 80% or 90% (based on all proteins present in said food product) plant protein. Most preferably, said plant protein food product comprises only or exclusively (i.e. 100% based on all proteins present in said food product) plant protein and no animal-derived at all. As used herein, the term “plant protein” refers to any protein from plant origin. Preferably, the plant protein is a protein from grains, pseudocereals, legumes, nuts, seeds or other sources such as coconut, potato, canola or tiger nut.

Examples of suitable grains are barley, fonio, maize, millet, oat, rye, sorghum, teff, triticale, spelt, rice or wheat.

Examples of suitable pseudograins are amaranth, buckwheat or quinoa.

Examples of suitable legumes are lupin, pea, chickpea, beans (preferably faba beans), duckweed, potato, peanut or soy.

Examples of suitable nuts are almond, brazil, cashew, hazelnut, macadamia, pecan, pistachio or walnut.

Examples of suitable seeds are canola seed, chia seed, flax seed, hemp seed, pumpkin seed, sesame seed or sunflower seed.

The term “microbial protein food product” as used herein refers to a “food product comprising a microbial protein” (alternatively referred to as “microbial protein comprising food product”; the phrases are used interchangeably herein) which refers to a food product which comprises at least 10% (based on all proteins present in said food product) microbial protein. Preferably, said microbial protein food product comprises at least 20%, 30%, 40%, 50%, 60%, 70%, 80% or 90% (based on all proteins present in said food product) microbial protein. Most preferably, said microbial protein food product comprises only or exclusively (i.e. 100% based on all proteins present in said food product) microbial protein and no animal-derived at all. Preferably, the microbial protein is a fungal protein or a bacterial protein and hence a fungal protein food product or a bacterial protein food product is obtained.

The term “fungal protein food product” as used herein refers to a “food product comprising a fungal protein” (alternatively referred to as “fungal protein comprising food product”; the phrases are used interchangeably herein) which refers to a food product which comprises at least 10% (based on all proteins present in said food product) fungal protein. Preferably, said fungal protein food product comprises at least 20%, 30%, 40%, 50%, 60%, 70%, 80% or 90% (based on all proteins present in said food product) fungal protein. Most preferably, said fungal protein food product comprises only or exclusively (i.e. 100% based on all proteins present in said food product) fungal protein and no animal-derived at all. An alternative term for a fungal protein is a mycoprotein Suitable examples of a mycoprotein are proteins derived from, for example, from Fusarium venenatum. Such a product is commercially available under the name Quom. Other suitable sources of mycoprotein are Neurospora crassa, Thermomucor indicae-seudaticae, Lentinula edodes (Shiitake), Pleurotus ostreatus (Oyster mushroom), Rhizopus, Fusarium oxysporum, Fusarium novum-yellowstonensis or Aspergillus oryzae (Koji).

The term “bacterial protein food product” as used herein refers to a “food product comprising a bacterial protein” (alternatively referred to as “bacterial protein comprising food product”; the phrases are used interchangeably herein) which refers to a food product which comprises at least 10% (based on all proteins present in said food product) bacterial protein. Preferably, said bacterial protein food product comprises at least 20%, 30%, 40%, 50%, 60%, 70%, 80% or 90% (based on all proteins present in said food product) bacterial protein. Most preferably, said bacterial protein food product comprises only or exclusively (i.e. 100% based on all proteins present in said food product) bacterial protein and no animal-derived at all. Suitable examples of bacterial proteins can be obtained from Xanthobacter tagetidis or Cupriavidus necator

The term “algal protein food product” as used herein refers to a “food product comprising an algal protein” (alternatively referred to as “algal protein comprising food product”; the phrases are used interchangeably herein) which refers to a food product which comprises at least 10% (based on all proteins present in said food product) algal protein. Preferably, said algal protein food product comprises at least 20%, 30%, 40%, 50%, 60%, 70%, 80% or 90% (based on all proteins present in said food product) algal protein. Most preferably, said algal protein food product comprises only or exclusively (i.e. 100% based on all proteins present in said food product) algal protein and no animal-derived at all. Suitable examples of algal proteins are Chlamydomonas, Spirulina (commercially produced by Damhert), Euglena gracilis, Odontella, Saccharina (commercially produced by Viva Maris) or Chlorella (commercially produced by Alver).

The herein described non-animal protein food product (for example microbial protein food product, fungal protein food product, bacterial protein food product or algal protein food product) or the herein described cultured meat food product is typically sold as a meat-alternative food product or a fish alternative food product. Hence, also described herein is a method for preparing meat alternative food product or a fish alternative food product comprising
adding a lactase protein preparation to an ingredient used in the preparation of said food product and processing the obtained lactase protein preparation and ingredient composition into a meat alternative food product or a fish alternative food product.

Alternatively, this aspect of the invention can be worded as:
a method for preparing a meat alternative food product comprising adding a lactase protein preparation to an ingredient used in the preparation of said food product and processing the obtained lactase protein preparation and ingredient composition into a meat alternative food product, or
a method for preparing a fish alternative food product comprising
adding a lactase protein preparation to an ingredient used in the preparation of said food product and processing the obtained lactase protein preparation and ingredient composition into a fish alternative food product.

The term meat- or fish-alternative, meat or fish analogue product, or meat or fish substitute, as used in the present context means a product that does not comprise animal or fish protein and thus is suitable to be used as a vegetarian or vegan meat- or fish-alternative and has an appearance mimicking an animal meat- or fish-based product. Meat- or fish-alternatives may be in the form of patties, nuggets, sausages, cold cut, spreads, sticks or any other form.

Alternatively, any of the above-described methods (i.e. a method for preparing a non-animal protein food product or a cultured meat food product or a method for reducing (preferably completely reducing) methylcellulose or egg white protein in preparing a non-animal protein food product or a cultured meat food product) is used to produce a non-animal protein food product such as a cheese, milk, egg or yoghurt like food product, for example a plant-based cheese (alternatively referred to as vegan cheese), a plant-based yoghurt, or plant-based milk alternative, plant-based ice-cream, or plant-based egg alternative like a vegan omelet, scrambled, frittata, quiche, or boiled egg etc.

Hence, also described herein is a method for preparing a non-animal protein food product comprising
adding a lactase protein preparation to an ingredient used in the preparation of said food product and processing the obtained lactase protein preparation and ingredient composition into a non-animal protein food product and wherein said food product is a plant-based cheese (alternatively referred to as vegan cheese), a plant-based yoghurt, plant-based milk alternative, plant-based ice-cream, or plant-based egg alternative such as a vegan omelet, scrambled, frittata, quiche, or boiled egg.

Alternatively, any of the above-described methods is used to produce a non-animal protein food product such as a bakery, patisserie, or confectionary products, for example vegan cake, meringues, gluten-free bread, waffles, pancakes, cookies, muffins, pastry creams, sauces and custards. Alternatively, any of the above-described methods is used to produce a non-animal protein food product such as noodles or pasta, or used to produce a batter or breading used in foods. Hence, also described herein is a method for preparing a non-animal protein food product comprising
adding a lactase protein preparation to an ingredient used in the preparation of said food product and processing the obtained lactase protein preparation and ingredient composition into a non-animal protein food product and wherein said food product is vegan cake, meringues, gluten-free bread, waffles, pancakes, cookies, muffins, pastry creams, sauces or custards.

Also described herein is a method for preparing a non-animal protein food product comprising
adding a lactase protein preparation to an ingredient used in the preparation of said food product and processing the obtained lactase protein preparation and ingredient composition into a non-animal protein food product and wherein said food product is noodles or pasta.

The lactase protein preparation used in any of the herein described methods is added to obtain binding properties and is not added to convert lactose into glucose and galactose. Preferably, said methods exclude the addition of lactose.

In yet another aspect, the invention further provides a food product obtainable by any of the methods described herein and hence the food products may be a meat-alternative or a fish-alternative or a non-animal protein food product or a cultured meat food product or any of the above-mentioned food products. Such a food product differs from other food products in that it comprises lactase. Prior art uses of a lactase are limited to dairy products such as milk, ice or a fermented milk product such as yogurt. The herein described food product does preferably not comprise any dairy protein and also not any lactose and hence lactase is not used to enzymatically convert lactose into glucose and galactose. Herein, lactase is used as a binder, preferably as a binder to replace methylcellulose or egg white protein. The lactase is added in much higher amounts when compared to its traditional use in dairy to convert lactose wherein typically ppm amounts of lactase protein is added.

The invention further provides a meat or fish alternative food product comprising non-animal protein or cultured meat and a lactase protein preparation. The explanation provided above for the different features in respect of the method claims equally apply to this part of the invention.

An additional component of such a meat or fish alternative food product is non-animal fat.

The invention also provides meat or fish alternative which comprises texturized vegetable protein, non-animal protein, water, flavour and a binder system, wherein the binder system comprises a lactase protein preparation. In one embodiment the lactase protein preparation can (also) be present in the texturized vegetable protein.

Preferably the present meat- or fish-alternative comprises texturized vegetable protein (TVP) Preferably the texturized vegetable protein is an extruded vegetable protein product. This can cause a change in the structure of the protein which results in a fibrous, spongy matrix, similar in texture to meat. The textured vegetable protein can be rehydrated or dehydrated. Preferably, the texturized vegetable protein is selected from soybean protein, pea protein, lentil protein, lupin bean protein, wheat gluten, rapeseed protein, fava bean protein or a combination thereof. Given that soy is an allergen, it is preferred that the present texturized vegetable protein is soy free. Preferably the present meat- or fish-alternative is soy free.

Preferably, the present meat- or fish-alternative comprises texturized vegetable protein in an amount from 5 to 30% (w/w), preferably an amount of 6 to 25% (w/w), preferably 8 to 20% (w/w), preferably 10 to 15% (w/w) of the meat- or fish-alternative

Preferably, the present meat- or fish-alternative comprises texturized vegetable protein with a protein amount from 50 to 99% (w/w), preferably an amount of 55 to 90% (w/w), preferably 60 to 85% (w/w) of the texturized vegetable protein.

Preferably, the present texturized vegetable protein is hydrated towards an amount of water of more than 10% (w/w) of the texturized vegetable protein, preferably an amount of water from 20 to 80% (w/w) of the texturized vegetable protein, preferably an amount of water from 30 to 70% (w/w) of the texturized vegetable protein.

The term “binder” or “binding agent” as used herein relates to a substance for holding together particles and/or fibres in a cohesive mass. It is an edible substance that in the final product is used to trap components of the foodstuff with a matrix for the purpose of forming a cohesive product and/or for thickening the product. Binding agents of the invention may contribute to a smoother product texture, add body to a product, help retain moisture and/or assist in maintaining cohesive product shape; for example by aiding particles to agglomerate. The amount of lactase protein preparation which needs to be added to get the desired binding effect can easily be determined by the skilled person. Guidance can be found in the experimental part herein. Based on total protein (present in the used lactase protein preparation) 0.05 to 10% is sufficient to result in binding.

Preferably the present meat- or fish-alternative does not comprise methyl cellulose and/or wheat gluten.

In a preferred embodiment, the present meat- or fish-alternative further comprises a nutrient, preferably wherein the nutrient comprises both vitamins and minerals, preferably vitamins chosen from the group consisting of B2, B3, B6 and B12, preferably minerals chosen from the group consisting of iron, selenium and zinc. The term “nutrient” as used herein relates to a substance that provide nutritional value to the present meat- or fish-alternative, such as vitamins, minerals, trace elements and antioxidants for example. The advantage of adding these nutrients is that the present meat- or fish-alternative more closely resembles the nutritional value of a real meat hamburger, without introducing off flavors to the meat- or fish-alternative.

In an embodiment, the present meat- or fish-alternative further comprises a vegetable oil and/or a vegetable fat. The vegetable oil and/or fat can be an algal oil, a fungal oil, corn oil, olive oil, soy oil, peanut oil, walnut oil, almond oil, sesame oil, cottonseed oil, rapeseed oil, canola oil, safflower oil, sunflower oil, flax seed oil, palm oil, palm kernel oil, coconut oil, babassu oil, shea butter, mango butter, cocoa butter, wheat germ oil, borage oil, black currant oil, sea-buckhorn oil, macadamia oil, saw palmetto oil, conjugated linoleic oil, arachidonic acid enriched oil, docosahexaenoic acid (DHA) enriched oil, eicosapentaenoic acid (EPA) enriched oil, palm stearic acid, sea-buckhorn berry oil, macadamia oil, saw palmetto oil, or rice bran oil; or margarine or other hydrogenated fats. In some embodiments, for example, the oil is algal oil. In a preferred embodiment, the present plant oil is sunflower oil and/or the present plant fat is coconut fat.

Preferably, the amount of vegetable oil is within the range from 2 to 20% (w/w) of the meat- or fish-alternative, such as from 5 to 15% (w/w) or from 7 to 12% (w/w). Preferably, the amount of vegetable fat is within the range from 0.5 to 5% (w/w) of the meat- or fish-alternative, such as from 1 to 3% (w/w) of the meat- or fish-alternative.

Preferably, the meat-alternative is a hamburger patty, a nugget, a minced meat, a meat ball or a sausage.

Preferably, the fish-alternative is a batter fish alternative, a fish burger alternative, a smoked fish alternative, a fish salad alternative or a fish ball alternative.

Preferably the meat- or fish-alternative comprises a protein or protein isolate or protein concentrate. Examples of proteins can be barley, fonio, maize, millet, oat, rye, sorghum, teff, triticale, spelt, rice, wheat, amaranth, buckwheat, quinoa, lupin, pea, chickpea, beans (preferably faba beans), duckweed, potato, lentil, peanut, soy, almond, brazil, cashew, hazelnut, macadamia, pecan, pistachio, walnut, canola, chia, flax, hemp, pumpkin, sesame, sunflower, mycoprotein (e.g. Quorn), mushroom or algae (e.g. Chlamydomonas, Spirulina, Euglena, Odontella, Saccharina, Chlorella). More preferably, the present meat or fish-alternative product comprises 0.001 to 20% (w/w) of a protein.

Preferably the meat- or fish-alternative comprises a flavour or flavour agent, or flavour precursor. Examples of flavours can be yeast extracts or process flavours. More preferably the present meat or fish-alternative product comprises 0.001 to 5% (w/w) of a flavour.

In an embodiment the present meat- or fish-alternative comprises a flavour modifier or a flavoring with modifying properties. More preferably the present meat- or fish-alternative comprises 0.001 to 1% (w/w) of a flavour modifier or a flavouring with modifying properties.

Preferably, the present meat- or fish-alternative comprises salt, preferable NaCl. The amount of salt is preferably within the range of 0.001 to 5% (w/w) of the present meat- or fish-alternative.

In a preferred embodiment, the present meat- or fish-alternative comprises a colorant, preferably within the range of 0.01 to 10 wt. %, more preferably 0.1 to 5 w. %, most preferably 0.2 to 2 wt. % of the meat- or fish-alternative. In a preferred embodiment, the present colorant comprises or is beet root or beet root powder. The advantage of using beet root is that a meaty like color is provided to the product, without introducing off flavors to the product. The present colorant can also be or comprise a carotenoid. Preferably, the carotenoid is chosen from the group consisting of α- or β-carotene, 8′-apo-β-carotenal, 8′-apo-β-carotenoic acid esters such as the ethyl ester, bixin, capsanthin, capsorubin, rhodoxanthin, canthaxanthin, astaxanthin, astaxanthin esters, lycopene, lutein, zeaxanthin or crocetin and their derivatives.

In an embodiment the present meat- or fish-alternative comprises a heme, a heme protein, a heme containing protein or a (macro) molecule with complexed iron. More preferably the present meat- or fish-alternative comprises 0.001 to 5% (w/w) of a heme, a heme protein, a heme containing protein or a (macro) molecule with complexed iron.

In an embodiment, the present meat- or fish-alternative comprises an amount of water within the range of 50 to 80% (w/w), preferably 55 to 70% (w/w).

In yet another aspect, the invention also provides use of a lactase protein preparation for obtaining binding in a food product or for at least partly replacing a binder in a food product. A binder can be part of a binder system. For example, the binder methylcellulose can be part of a binder system which additionally comprises oil, gums and water. Preferably, at least 10% or at least 20, 30 or 40% and more preferably at least 50, 60 or 70% and even more preferably at least 80, 90 or 95% of the binder is replaced and most preferred 100% of the binder is replaced by said lactase. Examples of binders which can be at least partly replaced are egg-white or methylcellulose. Described herein are use of a lactase protein preparation for at least reducing the amount of egg, egg-white or methylcellulose in a food product. More preferably, the invention provides use of a lactase protein preparation for at least partly replacing egg white as a binder in a non-animal protein food product or a cultured meat food product. Preferably, the food product is a meat-alternative food product or a fish-alternative food product or any of the above-described food products. More preferably, egg white is completely replaced as a binder. The explanation provided above for the different features in respect of the method and product claims equally apply to this part of the invention.

The invention will be explained in more detail in the following example, which are not limiting the invention.

### EXAMPLES

### Rheology Measurements

Dynamic oscillatory rheology was performed using an Anton Paar Physica rheometer MCR302 with a cup and bob geometry (CC27), and a program as displayed in table 1. During the measurements rheological data was obtained that is expressed as the complex modulus G*[Pa] and the phase angle [°]. The measurement was performed by filling the cup with 17-20 ml protein dispersion. To prevent samples from drying out during the experiment, the sample in the cup was covered with a thin layer of sunflower oil. The test program in detail: a temperature sweep was conducted, the sample was heated and then cooled over a temperature range of 25-95° C. with steps 2° C. per minute followed by a 10 minutes holding time at the final temperature of 95° C. A constant frequency of 1 Hz and strain of 0.1% were applied to collect data during the heat set and the cooling down phase. Rheological data were collected at 30 seconds intervals. After the gel was cooled, it was held at 25° C. for 10 minutes now with a frequency of 0.1 Hz and strain of 0.1%. During this step, rheological data were collected at 1-minute intervals. Subsequently, a strain sweep was performed on the heat-set protein gel, using a constant frequency of 0.1 Hz and increasing strain from 0.1 to 100% at a constant temperature of 25° C.

TABLE 1
Program settings of rheometer

| | | | | | | Total | |
|---|---|---|---|---|---|---|---|
| | | | | | | time of | Heating |
| | Temperature | Frequency | Strain γ | # of | Time per | the | rate |
| Step | [° C.] | [Hz] | [%] | points | point [s] | phase [s] | [° C./min] |
| 1 | 25 → 95° C. | 1 | 0.1 | 70 | 30 | 2100 | 2 |
| 2 | 95° C. | | | 20 | 30 | 600 | 0 |
| 3 | 95 → 25° C. | | | 70 | 30 | 2100 | −2 |
| 4 | 25° C. | 0.1 | | 10 | 60 | 600 | 0 |
| 5 | 25° C. | | 0.1 → | 31 | Set by | Set by | 0 |
| | | | 100 | (10 | rheometer | rheometer | |
| | | | logarithmically | points/ | | | |
| | | | | decade) | | | |

### Texture Profile Analysis (TPA)

Texture profile analysis was performed on a Texture analyzer (TA.TA.Xtplus, Stable Microsystems Ltd Surrey, UK) provided with the software “Exponent”. A cylindric probe with 45 mm diameter and a load cell of 5 kg was used. Double compression test to 30% deformation, at 3 mm/sec test speed with a 2 sec delay between first and second compression was performed. All samples were measured in 5-fold, and averages and standard deviation was calculated. Hardness, cohesiveness, springiness and resilience were calculated by the instrument software. Gumminess (hardness*cohesiveness) and Chewiness (hardness*cohesiveness*springiness) can be calculated herefrom.

### Lactase Preparations

Besides commercial lactase preparation as described in the Examples, also lysates of the yeast Kluyveromyces lactis were used in several experiments. For this a strain derived from Kluyveromyces lactis CBS683 by classical strain improvement to enhance the productivity of lactase, was grown under carbon limitation in a synthetic medium using glucose syrup as carbon source (GPP). Biomass from 11.1 kg fermentation broth was harvested by centrifugation at 5000 rpm at 4° C. for 20 minutes, and the concentrated yeast cream was washed with 100 mM phosphate buffer, pH 7.4 and centrifuged again under the same conditions. Cell lysis, to release the intracellular proteins material containing lactase, was performed on washed cream yeast (17.5% dry matter (w/w)) using homogenization with 2 passes at 900 bar in a Niro homogenizer. Both cream yeast and homogenate were kept cooled at 4° C. After homogenization the pH had dropped to 6.7 and was set back to pH 7.4 with NaOH before proceeding. Part of the lysed cell material was freeze dried as is (no preservatives or stabilizers added) (in a Beta 2-8 LDplus of Christ) in batches of 1 kg. Settings were 3 days at vacuum of 0.021 mB and a condenser temperature of −77° C. The freeze drying generated the sample “GPP hom”. Lysed cell material was purified by germ-filtration to remove the cell debris and remaining cells, and ultrafiltration on a 10 kDa cut-off membrane to concentrate the cell-free lysate. The concentrate (“GPP ccUF liquid”) was stored frozen. Part of the ccUF material was further freeze-dried to obtain a sample “GPP ccUF dried”. Plate counting to detect the presence of live microorganisms indicated that cell lysis had been >99% efficient, and the ccUF samples showed a very low microbial count. The Dumas method was used for measuring total organic nitrogen content in the samples, and multiplication by 6.25 was used to obtain the total protein content. The dried GPP hom sample contained 41% (w/w) protein, GPP ccUF liquid 17.5% (w/w) protein and GPP ccUF dried 70% (w/w) protein.

### Example 1: Heat-Set of Lactase Protein Preparations

Different lactase protein preparations were tested for heat-setting behavior by heating a 1 ml sample in a 2 ml Eppendorf tube for 5 minutes at either 60, 70 or 80° C. Liquid enzymes were directly tested, while enzymes in solid form were first resuspended at 15% (w/v) in cold 50 mM phosphate-buffer (pH 7.0) and solids were removed by centrifugation before the enzymes were tested. After heating the development of a self-supporting gel was recorded by inverting the tubes. The tested lactase protein preparations were:
Maxilact LGi5000 (DSM Food Specialties, the Netherlands)—a liquid preparation of microbial protein containing lactase activity, obtained from Kluyveromyces lactis. The preparation contains 50% glycerol, 2% KCl, and ˜4.8% protein. At all three tested temperatures the preparation forms a firm egg-white-like self-supporting gel. Other commercial liquid lactase preparations obtained from Kluyveromyces yeasts, like Godo YNL-2 (Dupont) and Lactozyme Pure (Novozymes), show similar properties.
Maxilact A4 (DSM Food Specialties, the Netherlands)—a preparation of microbial protein containing lactase activity, obtained from Aspergillus niger. The preparation contains 50% glycerol, 10% NaCl, and ˜2.2% protein. At 70 and 80° C. the preparation forms a transparent, sticky, self-supporting gel
Lactase containing samples isolated from K. lactis as described above; samples “GPP-hom”, “GPP ccUF” and “GPP ccUF dried” and Maxilact GF MG (DSM Food-Specialties, the Netherlands; a microgranulate comprising 25% protein and 50% maltodextrin that was made by spray drying a lactase concentrate) were suspended in water at 5% protein and tested for producing a heat-set gel as described above. All these lactase samples formed a heat-set gel at all three tested temperatures

TABLE 2
Heat-gelation behaviour of commercial lactases
from different bacterial and fungal sources

| Enzyme | Supplier | Origin | 60° C. | 70° C. | 80° C. |
|---|---|---|---|---|---|
| Maxilact GF MG (15%) | DSM | Kluyveromyces | + | + | + |
| | | lactis | | | |
| Maxilact LGX | DSM | Kluyveromyces | + | + | + |
| | | lactis | | | |
| Maxilact LGi | DSM | Kluyveromyces | + | + | + |
| | | lactis | | | |
| Maxilact A4 | DSM | Aspergillus | − | + | + |
| | | oryzae | | | |
| Godo YNL2 | Dupont | Kluyveromyces | ± | + | + |
| | | lactis | | | |
| Lactozyme Pure | Novozymes | Kluyveromyces | + | + | + |
| | | lactis | | | |
| Saphera | Novozymes | Bifidobacterium | − | − | + |
| | | bifidum | | | |
| Bonlacta | Dupont | Lactobacillus | − | + | + |
| | | bulgaricus | | | |
| Biolactase L | Kerry | Kluyveromyces | ± | + | + |
| | | lactis | | | |
| Denazyme GY2 | Nagase | Kluyveromyces | ± | + | + |
| | | lactis | | | |
| Lactase DS-K (15%) | Amano | Bacillus | ± | + | + |
| | | circulans | | | |
| Ha-Lactase | Chr. Hansen | Kluyveromyces | ± | + | + |
| | | lactis | | | |

### Example 2: Heat-Setting Behavior of Maxilact Compared to Egg-White

A 10% (w/v) solution of egg-white powder (Sanovo) was made in water by gently stirring until a homogeneous suspension is formed. The suspension contains a protein content of ˜9% (w/v). A 20% (w/v) solution of Maxilact GF MG (DSM Food-Specialties, the Netherlands) was made in water by gently stirring until a homogeneous suspension is formed. The suspension contains a protein content of ˜5% (w/v). Maxilact GF MG contains the same protein material as Maxilact LGi5000 described in Example 1, but in a microgranulate form. Approximately, 50% of the total protein present in Maxilact GF MG is lactase protein. One ml of each protein solution was heated in a 2 ml Eppendorf for 5 min. at 40, 50 or 60° C. and formation of a self-supporting gel was tested by inverting the tubes. The egg-white solution only formed a weak self-supporting gel at 60° C., while the Maxilact solution forms a firmer gel at both 50 and 60° C.

Samples of both the egg-white solution and the Maxilact solution were diluted with water before testing the heat-gelation for 5 min. at 70° C. The egg-white solution still formed a self-supporting gel when diluted to ˜5% (w/v) protein, but no gel was formed anymore at higher dilutions under these conditions. On the other hand, the Maxilact GF MG suspension still formed a self-supporting gel when diluted until 0.5% (w/v) protein.

Hence, Maxilact forms a heat-set gel at lower temperatures and at higher dilution than egg-white when tested at temperatures relevant for the binding activity in food applications.

### Example 3: Gel Strength and Elastic Behavior

A 5% (w/v) protein solution was made by carefully suspending 20% (w/v) Maxilact GF MG in water, and gelation was performed in the Rheometer. Heat gelation occurred between 5° and 60° C., and maximum gel strength during heating was obtained at ˜70° C. (FIG. 1A). Gel strength was significantly increased during the cooling period (compare y-axis in FIGS. 1A and 1B). The complex modulus of the cooled gel was hardly affected by the strain applied (FIG. 1B) indicating that the gel shows elastic behavior and does not break when applying strain.

A similar experiment was performed to compare the Maxilact protein with egg-white protein and potato protein at a comparable protein concentration. A 10% (w/v) protein solution was made by carefully suspending 40% (w/v) Maxilact GF MG in water. Similar suspensions at 10% (w/v) protein were made with egg-white powder (Sanovo) and Solanic 200 (Avebe, the Netherlands), a protein isolated from potato known for its good heat-set behavior. Both Maxilact and Solanic have a lower temperature gelation onset than egg-white protein, but the final gel strength at 95° C. of all three proteins is almost identical (FIG. 2A). After cooling the gel strength increases in all 3 proteins, with the most significant increase for the Maxilact protein. All 3 protein gels show roughly the same behavior when strain was applied after cooling (FIG. 2B). Hence, the rheological behavior of Maxilact is very comparable to that of egg-white protein and Solanic at similar protein concentrations.

### Example 4: Use of a Lactase Protein Preparation in a Binder System/Phase

For preparing a vegan meat replacer, a binder-phase containing a product that shows heat-gelling properties is mixed with oil, optionally a plant-based or microbial gum and water. This binder-phase is further blended with hydrated texturized vegetable protein (TVP), salt, flavorings and optionally additional plant protein, to form the dough from which vegan hamburgers are made.

We tested the use of Maxilact on the rheological properties of the binder phase. For this 6 g Gellan gum HA (GellaneerHD™-DSM Hydrocolloids) and 100 g Maxilact GF MG was blended into 120 g sunflower oil in a high speed kitchen mixer. After this, 216.6 g cold water was added to the blend and mixed for 5 min at maximum speed.

This emulsion was used in a rheology experiment as described in Example 3. The absolute complex modulus (G* in Pa) development in the Maxilact binder (total protein content ˜5.6%) after heating, was comparable to the complex modulus of Maxilact protein at 10% (w/v) in water (compare FIGS. 3A and 2A), and much higher than a comparable protein concentration (5%) in water (compare FIGS. 3A and 1A). This indicates that the additional components in the binder phase (oil emulsion and gellan gum) have an additive effect with Maxilact in forming a heat-set gel. Similar to the previous experiment, the Maxilact gel formed in the binder phase was cooled but now the strain sweep was performed at 50° C. (FIG. 3B). Again, the gel strength further increases when the gel is cooled and shows elastic properties when applying strain.

### Example 5: Use of a Lactase Protein Preparation in Vegan Nuggets

Vegan nuggets were made using the recipe below. No flavorings were added to allow detection of possible off-flavors of the added proteins.

TABLE 3
Composition of vegan nuggets. Amounts are mentioned in grams. Amount of total protein
added with Egg white powder or Maxilact is indicated below in italics (in brackets).

| | Reference | # 1 | # 2 | # 3 | # 4 | # 5 |
|---|---|---|---|---|---|---|
| protein added as | 3.38% | 0.27% | 1.03% | 1.75% | 2.43% | 3.07% |
| binder | | | | | | |
| Textura soy TVP | 65 | 65 | 65 | 65 | 65 | 65 |
| (ADM) | | | | | | |
| Water - part 1 | 225 | 225 | 225 | 225 | 225 | 225 |
| Water - part 2 | 85 | 85 | 85 | 85 | 85 | 85 |
| Sunflower Oil | 45 | 45 | 45 | 45 | 45 | 45 |
| (Albert Heijn) | | | | | | |
| Soy Protein isolate | 30 | 30 | 30 | 30 | 30 | 30 |
| (myprotein.com) | | | | | | |
| Potato Starch | 10 | 10 | 10 | 10 | 10 | 10 |
| (Perfectamyl D6 - | | | | | | |
| Avebe) | | | | | | |
| Egg White Powder | 20 (16.4) | 0 | 0 | 0 | 0 | 0 |
| (Sanovo - the | | | | | | |
| Netherlands) | | | | | | |
| Maxilact GF MG | 0 | 5 (1.25) | 20 (5.0) | 35 (8.75) | 50 (12.5) | 65 (16.25) |
| (DSM - the | | | | | | |
| Netherlands) | | | | | | |
| Salt | 3.05 | 3.05 | 3.05 | 3.05 | 3.05 | 3.05 |
| Dextrose | 1 | 1 | 1 | 1 | 1 | 1 |
| White Pepper | 0.5 | 0.5 | 0.5 | 0.5 | 0.5 | 0.5 |

Step 1 Texturized protein—Hydrate the Textura Soy TVP for 45 minutes in Part 1 water. Once the TVP is fully hydrated, paddle mix until flakey (10 minutes).
Step 2 Emulsion—Add the Soy Protein Isolate to a large MagiMix/Food Processor with a metal blade, secure the lid, switch to Auto and slowly add Part 2 water through the opening (over 1 minute), next, slowly dribble in the oil over a further 1 minute.
Step 3 Dry Ingredients—In a separate bowl, hand mix all remaining dry ingredients together.
Step 4 Combining ingredients—In a Kitchen Aid bowl, add all the ingredients together: first the Soy TVP from step 1 and the emulsion from step 2. Mix on low settings for a couple of minutes. Then add the dry Ingredients from step 3 and mix again on low settings for a couple of minutes.
Step 5 Shaping & deep frying—Shape the dough into desired sized nuggets (approximately 17-23 in total for each dough), then deep fry in oil at 190° C. for 30 sec. Let the nuggets cool down on absorbing paper then transfer to the freezer. It is recommended that the nuggets are allowed to rest for a minimum of 3 days in the freezer before use.
Step 6 Final Stage—Defrost before use. Preheat the Air Fryer to 180° C. Add the nuggets into the basket (single layer/uncrowded). Cook approximately for 5 minutes. Wait a couple of minutes before serving (time for the texture to set).

Tasting was performed by an experienced panel of 5 persons.

In conclusion the use of Maxilact leads to moist, juicy meat that is acceptable and less chewy than the use of egg white, even at the higher concentrations. The #1 nuggets are too soft and not acceptable. The highest concentrations (#4 and #5) lead to more browning after cooking but give an acceptable texture. The egg-white powder containing reference nuggets had a soy/bread taste that is absent in the nuggets prepared with lactase as binder. Taste of especially #2 and #3 nuggets is pleasant without off-flavors.

### Example 6: Use of a Lactase Protein Preparation in Vegan Hamburgers

The ingredients as shown in table 4 are used in preparation of the hamburgers in the following order. First caramelized sugar and beetroot powder are dry mixed separately and then added to water 1. This solution is used to hydrate TVP TU-crumble caramel 180 (ADM) and left for hydration for at least 45 minutes at room temperature. During those 45 minutes, the product is mixed for 15 seconds every 15 minutes, using a Hobart kitchen machine.

To prepare the binder phase, first the solid ingredients and oil are mixed in a Magimix for 45 seconds. Then the liquid ingredients and ice-cold water is slowly added while mixing under high shear. At this stage the paste like emulsion is ready and subsequently hand mixed with the hydrated TVP until homogenous appearance of the dough. Finally, the dry parts soy protein isolate, flavours and salt are mixed in the dough, followed by the frozen coconut fat chunks. Added protein concentration of the tested samples in the final burger is calculated to be 3% (w/w) and substitutes the 3% soy protein isolate (SPI) in the control burgers.

The homogenous dough is chilled for 1 hour in the fridge. Hamburgers of 130 grams each are subsequently shaped with the use of a mould. The hamburgers are blast frozen for 90 minutes and then transferred to a normal freezer. The hamburgers are stored in the freezer for at least 3 nights before use. The day before the cooking the hamburgers are removed from the freezer and placed in the fridge to thaw. The starting temperature of the burgers before cooking is 7° C. A grill plate is set at 160° C., and burgers are cooked for 7 minutes at one side until core temperature was 75° C., then the burger is turned around and cooked for another 7 minutes at the other side.

TABLE 4
Ingredients of vega-burger using Maxilact in the binder phase.

| | | | | GPA + | |
|---|---|---|---|---|---|
| | | | GPA + | GPP | GPA + |
| Ingredients (in weight %) | MC | GPA | ML MG | ccUF | EWP |
| TVP TU-crumble caramel 180 (ADM) | 14 | 14 | 14 | 14 | 14 |
| Caramelized sugar ncs 23p from Buisman | 0.2 | 0.2 | 0.2 | 0.2 | 0.2 |
| Beet root from Diana | 0.3 | 0.3 | 0.3 | 0.3 | 0.3 |
| water 1 (hydration) | 32.5 | 32.5 | 32.5 | 32.5 | 32.5 |
| Methylcellulose (methocel) | 1.5 | | | | |
| Gellan Gum HA (GellaneerHD ™; DSM) | 0.6 | 0.6 | 0.6 | 0.6 | 0.6 |
| Pectin APC200Y (Andre Pectin) | | 0.5 | 0.5 | 0.5 | 0.5 |
| Aglufiber FAS (Silvateam) | | 1.0 | 1.0 | 1.0 | 1.0 |
| Maxilact GF MG | | | 12 | | |
| GPP ccUF liquid | | | | 17.2 | |
| Egg white powder | | | | | 3 |
| sunflower oil from local brand | 8 | 8 | 8 | 8 | 8 |
| Ice cold water 2 | 35 | 35 | 35 | 22.1 | 35 |
| Soy protein isolate (myprotein.com) | 3 | 3 | | | |
| Salt | 0.67 | 0.67 | 0.67 | 0.67 | 0.67 |
| Flavors | 2.2 | 2.2 | 2.2 | 2.2 | 2.2 |
| Coconut fat | 2 | 2 | 2 | 2 | 2 |

MC: methylcellulose;
GPA: gellan, pectin, Aglufiber;
ML MG: Maxilact GF MG;
GPP ccUF: GPP ccUF liquid;
EWP: egg white powder

Hardness of samples of the raw and cooked burgers was determined by TPA as described above with a probe of 25 mm. Raw burgers were analyzed at 10° C., cooked burgers at 50° C. Relative increase of hardness upon cooking is an indicator of the effectiveness of the tested ingredients in heat gelation. It was calculated by dividing the hardness (g) of the cooked burgers by the hardness (g) of the raw burgers. Results are indicated in Table 5 and show that different samples containing lactase protein led to a clear increase in hardness upon cooking, comparable or even higher than the relative increase in hardness with methylcellulose or egg-white.

TABLE 5
Fold increase in hardness of vegan burgers upon cooking

| | |
|---|---|
| Methylcellulose/gellan | 3.0 |
| gellan/pectin/aglufiber (GPA) | 1.2 |
| GPA + Maxilact GF MG | 4.3 |
| GPA + GPP ccUF | 4.5 |
| GPA + egg white powder | 3.4 |

### Example 7: Use of a Lactase Protein Preparation in a Vegan Omelet

A 5% (w/w) protein solution was made by whisking 20% (w/w) Maxilact GF MG in water. Salt and pepper was added. No flavorings were added to allow better judgement of possible off-flavors. Vegetable oil was heated in a frying pan, and the Maxilact solution was added. The protein started to coagulate immediately and a baked, slightly brown, omelet was formed after a few minutes. Tasting indicated a nice savory flavor without any clear off-notes. Texture of the omelet was moist and slightly soft.

### Example 8: Sensory of a Lactase Protein Preparation as Boiled Egg

A 10% (w/w) protein solution was made by mixing either 40% (w/w) Maxilact GF MG, or 25% (w/w) GPP-hom in water. The powders were allowed to swell/dissolve for 10 minutes at room temperature. As a control a 10% (w/w) egg white protein solution was made. All solutions were heated to 100° C. for 10 minutes in small cups. The gels formed were tasted and compared by a small expert panel.

Heated Maxilact GF MG had a bright white colour and a pleasant, slightly savoury, grainy flavor and a mouthfeel familiar to boiled egg white. GPP-hom had a slightly brown colour and a much stronger, yeasty or earthy flavour. Both samples lacked a clear egg-flavour. Therefore, a similar experiment was performed with 40% (w/v) Maxilact GF MG and addition of 0.1% Maxavor key Sulfur YEX-H+0.05% Maxarome Ultra (DSM Food Specialties, the Netherlands). Again the color of the boiled Maxilact GF MG solution was bright white and the flavour was much more egg like with salt/umami and sulphury tones.

### Example 9: Texture Analysis Lactase Protein Preparation as Boiled Egg

10% (w/w) protein solutions were made by mixing 14.3 g GPP ccUF dried until 100 g with water. The powder was allowed to swell/dissolve for 1 hour at room temperature. As a control a 10% (w/w) egg white protein (Ovadan) solution was made. All solutions were heated to 100° C. for 10 minutes in small silicon cups in the steam oven. After cooling, the gelled material was carefully removed from the cups and analysed in 5-fold using TPA. Averaged results are shown in Table 6, and show a textural profile of the test samples that is almost comparable to the egg white samples. Also the colour of the test samples was comparable to boiled egg white.

TABLE 6
TPA results of “boiled egg” made with
GPP ccUF dried and egg white powder

| | | GPP ccUF | Ovadan |
|---|---|---|---|
| | | dried | EWP |
| Hardness | g | 977 | 1330 |
| Resilience | % | 36.3 | 41.5 |
| Cohesiveness | % | 84.4 | 83.8 |
| Springiness | % | 92.6 | 93.9 |
| Gumminess | g | 825 | 1114 |
| Chewiness | g | 766 | 1046 |

### Example 10: Use of a Lactase Protein Preparation in Vegan Nuggets

A vegan nugget dough similar to the one described in Example 5 was prepared. For this experiment the composition of the dough was slightly adapted, and the composition of the nuggets that were used as model system can be found in table 7.

TABLE 7
Composition of nugget dough:

| | | | | |
|---|---|---|---|---|
| | | GPP | GPP | GHP |
| Ingredient | EWP | ccUF | hom | hom |

Part I

| | | | | |
|---|---|---|---|---|
| Texturized pea protein (Nutralys TP-C-EXP) | 13 | 13 | 13 | 13 |
| Water | 45 | 45 | 45 | 45 |

Part II

| | | | | |
|---|---|---|---|---|
| Sunflower oil (Albert Heijn) | 9 | 9 | 9 | 9 |
| Soy protein isolate (My vegan) | 6 | 6 | 6 | 6 |
| Water | 17 | 17 | 17 | 17 |

Part III

| | | | | |
|---|---|---|---|---|
| Egg white powder (~80% w/w protein) | 4 | | | |
| GPP ccUF dried (~70% w/w protein) | | 4.62 | | |
| GPP hom (~40% w/w protein) | | | 8.07 | |
| GHP hom (~65% w/w protein) | | | | 4.97 |
| Potato starch Perfectamyl D6 (Avebe) | 2 | 2 | 2 | 2 |
| Salt | 1.3 | 1.3 | 1.3 | 1.3 |

The nugget dough was built up of 3 parts. Part I was the texturized pea vegetable protein (Nutralys TP-C-EXP) that was first hydrated for at least 45 minutes using tap water. Per 100 grams of dough 13 grams of TVP was hydrated with 45 grams of water. The hydrated TVP was mixed for 10 minutes at slow speed into a homogeneous dough using a Kenwood kitchen machine, and a stainless-steel K-beater KW712205. Part II was an emulsion and was prepared by mixing first soy protein isolate (6 g/100 g dough) and 17 g/100 g tap water using a Magi mix 4200XL with Sabatier blade. After it was well mixed 9 g/100 g sunflower oil was gradually added. Part I and II were mixed in the Kenwood kitchen machine bowl. The dry ingredients of part III were weighed, added and mixed in as well. Mixing was prolonged for 2 minutes. Extra protein addition in part III is an estimated 3.2% on total nugget dough weight.

To be able to do textural analysis on the nuggets, the material was not fried like in Example 5, but cooked in a steam oven in muffin forms. A mini muffin baking tray [diameter of muffin is 5 cm] was filled with 20 grams of dough to fill a single well. The nuggets were heated for 15 minutes at 125° C. and 60% humidity in a steam oven.

TPA analysis was performed on the baked nuggets both directly after cooling to 25° C. and after storage for 2 days at 4° C. Averaged results of are depicted in Table 8. Using GPP ccUF dried as heat binder in this experiment shows results similar to using egg white. Hardness and the related gumminess and chewiness increase ˜1.5 fold upon storage of the nuggets at 4° C., similar to nuggets made using egg white. Nuggets made using GPP ccUF showed even a lighter colour appearance, more familiar of cooked chicken meat, compared to nuggets made with egg white. Hence, this lactase-containing yeast extract is useful as vegan heat binder to replace egg white.

Similar results were obtained using a K. lactis yeast homogenate fraction (GPP hom) containing lactase. As a control, also a similar homogenized yeast sample was produced from baker's yeast Saccharomyces cerevisiae biomass (GHP hom). Baker's yeast is rich in protein but lacks lactase. As can be seen in Table 8, both GPP ccUF dried and GPP hom lead to textural properties of the nuggets that are similar to the use of egg white protein. The yeast extract without lactase (GHP hom) shows however a much weaker texture after baking, indicating that the presence of lactase is important for good heat gelation.

TABLE 8
TPA results of nuggets made with egg white, GPP ccUF dried, GPP hom or GHP hom

| | | | GPP | | | | | | |
|---|---|---|---|---|---|---|---|---|---|
| | | Egg | ccUF | GPP | GHP | Egg | GPP ccUF | GPP | GPH |
| | | white | dried | hom | hom | white | dried | hom | hom |
| | ° C. | 25 | 25 | 25 | 25 | 4 | 4 | 4 | 4 |
| Hardness | g | 3661 | 4388 | 3630 | 1386 | 3907 | 4704 | 3900 | 1792 |
| Resilience | % | 65.0 | 56.9 | 49.0 | 25.7 | 66.8 | 60.7 | 50.4 | 22.4 |
| Cohesiveness | % | 88.9 | 84.6 | 77.8 | 53.4 | 89.3 | 86.8 | 77.6 | 49.9 |
| Springiness | % | 97.6 | 88.8 | 86.2 | 57.4 | 110.9 | 99.6 | 89.0 | 57.9 |
| Gumminess | g | 3255 | 3709 | 2826 | 739 | 3478 | 4082 | 3023 | 892 |
| Chewiness | g | 3195 | 3303 | 2437 | 424 | 3665 | 4064 | 2686 | 517 |

### Example 11: Use of a Lactase Protein Preparation in a Cheese Alternative

A vegan cheese was produced with Maxilact ccUF liquid at final protein content of 4.7% (w/w). Recipe of the ingredients is shown in Table 9.

TABLE 9
ingredients used to prepare a cheese alternative

| | Maxilact |
|---|---|
| | % |
| Coconut oil (Delfia) | 16.8 |
| Potato starch CS75 | 12.6 |
| Water | 36.9 |
| Gellan gum | 0.3 |
| Lactic Acid (85%) | 0.1 |
| Sunflower oil | 4.2 |
| CaCl₂ | 0.2 |
| Salt | 1.3 |
| Maxilact ccUF liquid | 26.9 |
| Potassium Sorbate | 0.8 |

For making a cheese alternative, the dry ingredients potato starch, gellan gum, salt and potassium sorbate were dry blended. Water was added to the Thermomixer and mixed at speed 3 at room temperature. The dry ingredients were added at mixed and heated until 70° C. for 3 minutes while the speed was gradually increased from 3 to 6. CaCl₂) was added and mixture was mixed at speed 6, 90° C. for 7 min. Coconut oil and sunflower oil were pre-melted, added to the mixer and incubation was continued for 10 min. under the same conditions. Maxilact ccUF liquid was added, incubation was continued for 3 minutes, and finally lactic acid was added with an extra 1 min mixing. The contents were scraped in a cheese mold and left at room temperature to cool before placing in a freezer for 1 hour. Cheese blocks were removed from the mold and stored in plastic bags in the fridge.

After 1 and 2 weeks storage the cheeses were tested in a sensory panel and by measuring hardness using TPA. The cheese was bright white in color and had a hardness of 2668 g measured with TPA after 1 week storage. The texture was perceived as smooth, and not too hard in the sensory panel.

### FIGURE LEGENDS

FIG. 1: Rheological assessment of a 5% Maxilact protein solution in water. A; Complex modulus (G* in Pa) versus temperature. B; Complex modulus (G* in Pa) versus strain in heat-set gel performed at 25° C.

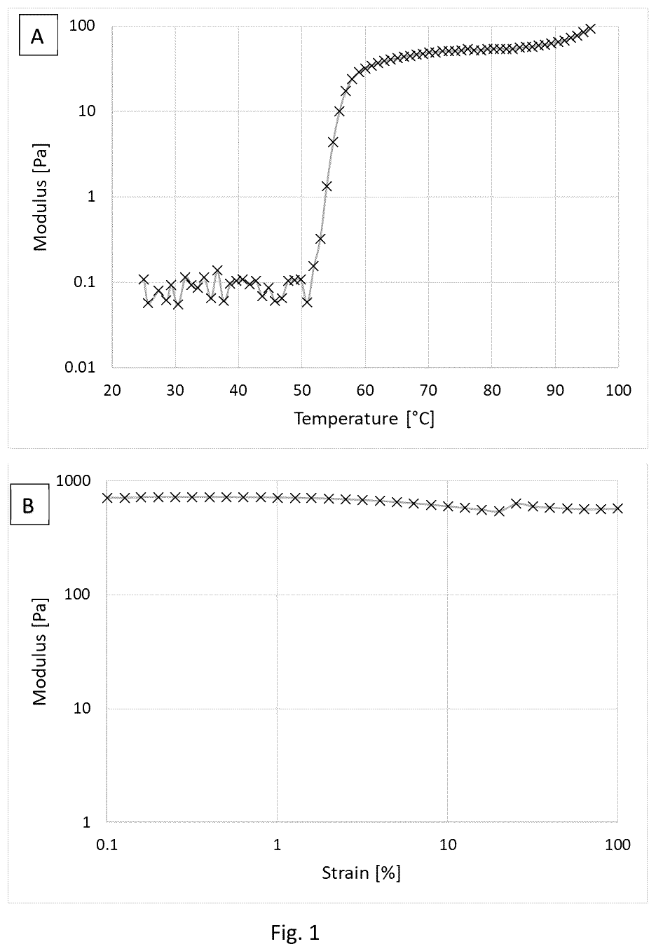

FIG. 2: Rheological assessment of a 10% Maxilact protein (cross), 10% egg white protein (circles) and 10% Solanic solution (squares) in water. A; Complex modulus (G* in Pa) versus temperature. B; Complex modulus (G* in Pa) versus strain in heat-set gel performed at 25° C.

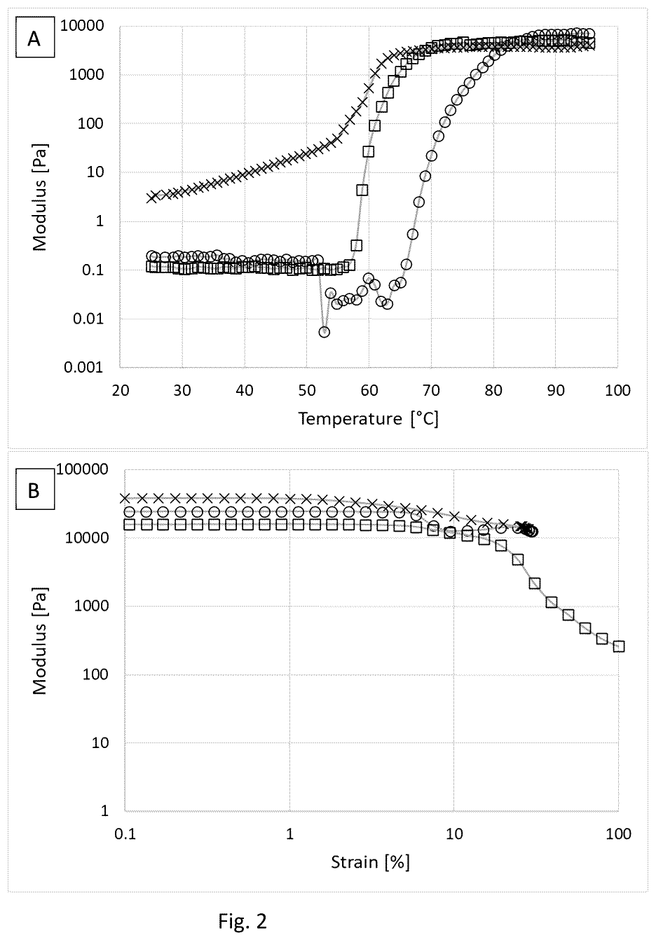

FIG. 3: Rheological assessment of a 5.6% Maxilact protein solution in binder phase. A; Complex modulus (G* in Pa) versus temperature. B; Complex modulus (G* in Pa) versus strain in heat-set gel performed at 50° C.

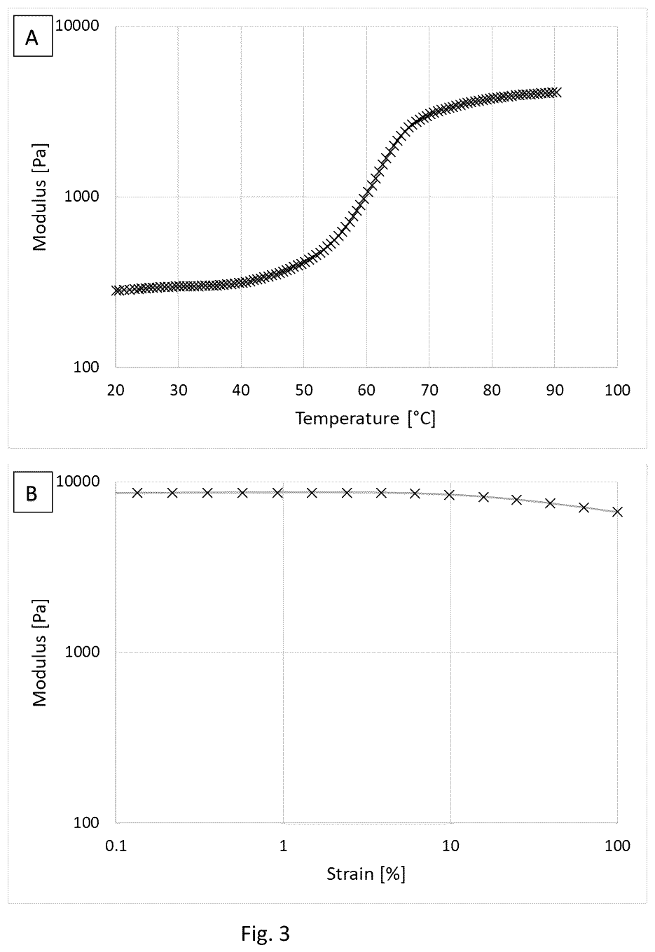

1. A method for preparing a non-animal protein food product or a cultured meat food product comprising adding a lactase protein preparation to an ingredient used in preparation of said food product and processing an obtained lactase protein preparation and ingredient composition into a non-animal protein food product or a cultured meat food product.

2. The method of claim 1, wherein said lactase protein preparation provides binding properties to the food product when said lactase protein preparation and ingredient composition or said food product is heated to at least 45 degrees Celsius.

3. The method of claim 1, wherein the method further comprises heating to at least 45 degrees Celsius.

4. The method of claim 1, wherein said food product does not comprise an egg-protein.

5. The method of claim 1, wherein said lactase protein preparation comprises
a native lactase protein
a yeast lactase protein
a Kluyveromyces lactase protein
a Kluyveromyces lactis lactase protein
a classical (non-GMO) lactase protein,
an intracellularly produced lactase protein, and/or
any combination thereof.

6. The method of claim 1, wherein said non-animal protein is plant protein, microbial protein or algal protein.

7. The method of claim 6, wherein said microbial protein is fungal protein or bacterial protein.

8. The method of claim 1, wherein said non-animal protein food product or said cultured meat food product is a meat-alternative food product or a fish alternative food product.

9. A food product obtainable by the method of claim 1.

10. A meat or fish alternative food product comprising non-animal protein or cultured meat and a lactase protein preparation.

11. The meat or fish alternative food product of claim 10, further comprising non-animal fat.

12. A meat or fish alternative which comprising texturized vegetable protein, non-animal protein, water, flavour and a binder system, wherein the binder system comprises a lactase protein preparation.

13. A product comprising a lactase protein preparation for obtaining binding in a food product or for at least partly replacing a binder in a food product.

14. The product of claim 13, wherein all binder is replaced by said lactase protein preparation.

15. The product of claim 13, wherein said binder is egg-white.

16. The product of claim 13, wherein said binder is methylcellulose.

17. The product of claim 13, wherein said food product is a meat-alternative food product or a fish-alternative food product.
